(19) United States
(12) Patent Application Publication
(10) Pub. No.: US 2004/0080070 A1
(43) Pub. Date: Apr. 29, 2004

(54) Method of manufacturing polymeric foam using supercritical fludis

(75) Inventors: Hsin-Chu Liu, Changhua (TW); Hsi-Hsin Shih, Taichung (TW); Chin-Chin Tsai, Taichung (TW); Chien-Tsung Wu, Taichung (TW); Wen-Bing Liu, Taipei (TW)

Correspondence Address: SUGHRUE MION, PLLC, 2100 PENNSYLVANIA AVENUE, N.W., SUITE 800, WASHINGTON, DC, 20037, US

(73) Assignee: INDUSTRIAL TECHNOLOGY RESEARCH INSTITUTE

(21) Appl. No.: 10/669,697

(22) Filed: Sep. 25, 2003

(30) Foreign Application Priority Data
Oct. 23, 2002 (TW) 91124487

(51) Int. Cl. B29C 44/02

(52) U.S. Cl. 264/51; 264/54

(57) ABSTRACT

A method of manufacturing polymeric foam. The invention is related to a method of manufacturing polymeric foam by allowing supercritical fluids to diffuse into polymeric material placed in a mold directly through the mold to impregnate the polymeric material.

### BACKGROUND OF THE INVENTION

1. Field of the Invention

The present invention relates to a method of manufacturing polymeric foam using supercritical fluids, and in particular, supercritical fluid being introduced directly into a mold to impregnate a polymeric material therein for producing polymeric foam.

2. Description of the Related Art

Conventional high-foamed compression molded foams are produced in two stages. For example, first, a low-foamed and low-crosslinked foam is formed by a first stage of crosslinking and foaming reactions, at a high pressure and a high temperature, of a mixture containing a polymer, a foaming agent, a crosslinking agent, and other additives charged fully in a mold in a compression molding machine, and second, the low-foamed and low-crosslinked foam is placed in another mold in a compression molding machine to perform a second stage of crosslinking and foaming reactions at a low pressure and a high temperature to form a high-foamed and high-crosslinked foam. Such a process can be used to produce thick plate material, but has the disadvantages of requiring a large amount of foaming agent and a lengthy processing time.

Recently, there has been a method of making polymeric microcellular foam by injecting a supercritical fluid into a barrel of an injection molding machine, allowing the supercritical fluid to disperse uniformly in a polymeric melt therein, and injecting the resultant into a mold. Although such an injection process can produce a thin sheet of microcellular foam, it has the disadvantage that the foam made thereby has a relatively low expansion ratio and a crosslinked polymeric material can not be accomplished by such a process.

U.S. Pat. No. 5,158,986 discloses a super microcellular foamed material and a method for producing such material, the material to be foamed such as a polymerplastic material, having a supercritical fluid, such as carbon dioxide in its supercritical state, introduced into the material to form a foamed fluid/material system having a plurality of cells distributed substantially throughout the material. The cell densities of the material obtained range from about 10⁹ to about 10¹⁵ per cubic centimeter, with the average cell sizes being at least less than 2.0 microns and preferably in a range from about 0.1 micron to about 1.0 micron. However, this conventional method can only produce a relatively thin article and the shape variation of the article is restricted to the feed path for polymer melt, in addition the feasibility of application to crosslinked polymer material is very low.

### SUMMARY OF THE INVENTION

Accordingly, an object of the invention is to provide a method of manufacturing polymeric foam using supercritical fluids. The method comprises the steps of placing a foamable polymeric material in a mold, introducing a supercritical fluid through the mold at a first temperature and at a first pressure for a time period sufficient to impregnate the polymeric material, changing the first temperature and the first pressure to an second temperature and a second pressure sufficient to produce the polymeric foam having microcells.

The present invention has the advantages that a thick plate article can be manufactured using a compression molding process without requiring a large amount of chemical foaming agent or a long processing time as is needed in conventional methods. Microcellular foam material with a high expansion ratio can be made in one stage as compared to the two-stage method used in conventional compression molding processes. Additionally microcellular foam as well as crosslinked polymer foam can be manufactured while maintaining the advantages of the conventional injection process for manufacturing the microcellular foam and solving -the problem of the inability of the conventional injection to manufacture crosslinked polymeric foam.

A detailed description is given with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a diagram showing one embodiment of the present invention, with the reference numbers as follows: 1˜CO₂/N₂ cylinder, 2˜regulator, 3˜pump, 4˜back pressure regulator, 5˜metering valve, 6˜pressure indicator, 7˜mold, 8˜conduit, 9˜polymeric material, and 10˜clamp mechanism;

FIG. 2a is a micrograph of the sample No. 5-4 obtained from example 5;

FIG. 2b is a micrograph of the sample No. 5-6 obtained from example 5;

FIG. 2c is a micrograph of the sample No. 5-9 obtained from example 5;

FIG. 3a is a micrograph of the sample No. 5-1 obtained from example 5;

FIG. 3b is a micrograph of the sample No. 5-12 obtained from example 5;

FIG. 3c is a plot of number of cells against cell size for the sample No. 5-1 obtained from example 5;

FIG. 3d is a plot of number of cells against cell size for the sample No. 5-12 obtained from example 5;

FIG. 4 is a plot of the foams specific gravity and dielectric constant against mold temperature, respectively, for the samples obtained at different mold pressures and mold temperatures in example 6; and

FIGS. 5a, 5b, and 5c are micrographs of the samples obtained at different mold pressures and mold temperatures in example 6, showing the distribution of cells.

### DETAILED DESCRIPTION OF THE INVENTION

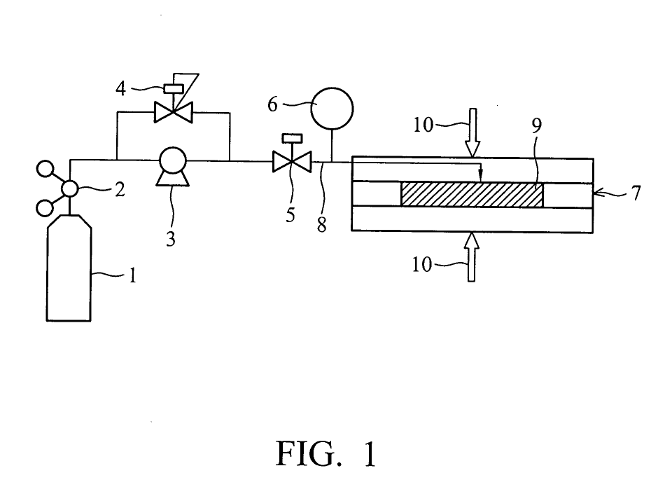

The method of manufacturing polymeric foam using supercritical fluids of the present invention is described in detail as follows, referring to FIG. 1.

In step (a) of the present invention, polymeric material 9 is placed in a mold 7. Mold 7 is placed in a conventional compression molding machine or an injection molding machine. The mold is in an environment where the temperature is adjustable to allow the mold to achieve a desired temperature. The temperature can be adjusted by, for example but not limited to, a coil heating and cooling device or a radiation device. The desired temperature depends on the condition required, for example, the product properties.

Suitable polymeric material in the present invention is foamable polymeric material, such as thermoplastic, thermoplastic elastomers, partially crosslinked thermoplastics, partially crosslinked thermoplastic elastomers, crosslinked thermoplastics, crosslinked thermoplastic elastomers, and the combination thereof.

Suitable thermoplastics include but are not limited to polyethylene (PE), polypropylene (PP), ethylene-propylene resins, polystyrene (PS), polyphenylene oxide (PPO), polyamides (PA), vinyl polymers, polysulfones (PSF), polyphenol sulfones (PPS), polyether sulfones (PES), acrylonitrile-butadiene-styrene copolymers (ABS), polyester resins, acrylic polymers, polycarbonate (PC), cyclo olefin copolymer (COC), liquid crystal polymers (LCP), polyether imides (PEI), polyimides (PI), biodegradable polyesters, fluorinated resins, polyetheretherketones (PEEK), and the combination thereof.

The suitable thermoplastic elastomers include but are not limited to ethylene-vinyl acetate copolymer (EVA), olefinic polymer, styrenic polymer, copolyamides copolyesters, and the combination thereof.

Polymeric material 9 can be a polymer or a mixture of more than one polymer and can further contain a suitable amount of chemical crosslinking agents, chemical foaming agents, and additives, such as colorants, plasticizers, and the like. The polymeric material can be kneaded in advance to form pellets, melt, or shaped articles which have not foamed, and then placed in a mold. The mold can be completely or partially full of the polymeric material. In the case of the polymeric material containing chemical crosslinking agents, foaming and crosslinking can be performed in one step. In the case of polymeric material containing chemical foaming agents, the chemical foaming agents can function as nuclei of cells, i.e. nucleating agents, forming microcellular foam.

The thermoplastics, thermoplastic elastomers, or the combination thereof suitable for the present invention can be crosslinked or partially crosslinked in advance, and then placed in the mold to proceed with subsequent steps.

Alternately, the non-crosslinked or partially crosslinked polymeric material, optionally containing chemical cosslinking agents, can be placed in mold 7 and then subjected to physical crosslinking by, for example, heating or radiation in the same step that supercritical fluids impregnate the polymeric material.

In the step of the present invention, in which a supercritical fluid is introduced, a supercritical fluid, through conduit 8, enters mold 7 by one or more entrances on mold 7, and optionally through supercritical fluid flow splitting channels and micro-pathways as well to impregnate the polymeric material at a first temperature and at a first pressure under which conditions the supercritical fluids exist. A supercritical fluid has a density and a diffusion coefficient similar to those of liquid, a viscosity similar to that of gas, a very high reaction rate, and an extremely small (approximately zero) surface tension. When the polymer is mixed with a supercritical fluid, the Tg of the polymer decreases. When the supercritical fluid enters mold 7 for a period of time, polymeric material 9 in mold 7 can be impregnated with the supercritical fluid. The temperature, pressure, and time are controlled properly according to the properties of the polymeric material and the products desired to achieve a desired amount of impregnated supercritical fluid.

The supercritical fluid used in the method can be any gas or liquid which reaches a supercritical condition. Among them, it is preferably the supercritical fluid which is in a gaseous state at room temperature and non-noxious, for example, carbon dioxide, nitrogen, argon, and the like which independently reach the supercritical condition. Supercritical carbon dioxide is most preferred because carbon dioxide has a supercritical pressure and temperature in the range suitable for industrial scale production, a higher impregnation ability than other general inert gasses, incombustibility, and reusability to alleviate greenhouse effect.

For example, when the present invention is practiced using supercritical carbon dioxide, in the step in which supercritical fluid is introduced, the first temperature can be set at from 60 to 380° C., the first pressure can be set at from 1000 to 5000 psi, and such temperature and pressure are maintained for several hours. The ratio of the amount of supercritical carbon dioxide to the amount of polymeric material depends on the desired cell size of the polymeric foam and is preferably in the range of 2:98 to 6:94 for carbon dioxide:polymeric material (w:w).

Also for example, when the present invention is practiced using supercritical nitrogen, in step (b), the first temperature can be set at from 100 to 400° C., the first pressure can be set at from 1000 to 8000 psi, and such temperature and pressure are maintained for several hours. The ratio of the amount of supercritical nitrogen to the amount of polymeric material depends on the desired cell size of the polymeric foam and is preferably in the range of 1:99 to 4:96 for nitrogen:polymeric material (w:w).

The method of the present invention uses supercritical fluids to perform the foaming mechanism, and may use only a small amount of chemical foaming agents as cell nuclei to form microcellular foam. Microcellular foam has the properties of very small cell size, good surface texture, very high cell density, specific gravity of foam between 0.05 and 0.95, excellent impact strength, excellent specific toughness, high specific stiffness, high fatigue strength, long product life, high tensile strength and compression strength, high heat stability, low heat conductivity, suitable for use at a low temperature, and a low dielectric constant.

In the temperature change step of the method, the first temperature and the first pressure are changed to a proper second temperature and a proper second pressure, to form polymeric foam. In supercritical fluid introduction step, the polymeric material is impregnated with supercritical fluids at a high temperature, and then in the temperature change step, by changing the temperature and pressure, the oversaturated gas inside the polymeric material is nucleated, resulting in microcells and formation of polymeric foam.

The method of the present invention provides a mold which can be employed by a conventional compression molding machine or an injection molding machine; therefore, the method can adapt to a compression molding process or an injection molding process without requiring the modification of existing equipment. The conditions for foaming depend on the intrinsic quality of the polymeric material and the desired properties of the produced article. The expansion ratio is various and may be as high as 40 and as low as 1.2. The basic controlling conditions are the amount of supercritical fluids impregnated inside the polymeric material, the temperature of the polymeric material, and the pressure of supercritical fluids. The amount of gas required by the foaming process is generally about 0.1 to 2 wt % based on the total weight of the product while the amount of gas needed in a microcellular foaming process is generally about 1 to 10 wt % based on the total weight of the product.

The microcellular foam obtained by the method of the present invention has excellent mechanical and thermophysical properties.

### EXAMPLES

### Example 1-2

### The Manufacture of Metallocene Polyethylene Microcellular Foams

In Examples 1 and 2, microcellular foams were made using metallocene polyethylene manufactured by Union Chemical Laboratories, Industrial Technology Research Institute, Hsin Chu, Taiwan. Initially, the metallocene polyethylene additionally contained only additives, and was made into a plate (in Example 2, the plate was further irradiated with γ-ray for crosslinking). The plate was placed in a mold and heated. The mold was charged with supercritical carbon dioxide, and then opened to cause pressure reduction, forming a microcellular foam article. The supercritical fluids, mold temperatures, and mold pressures used for making various samples, and the properties for the samples are shown in Table 1.

As known from the data shown in Table 1, the factor which most influenced the specific gravity and cell size of the foam was the mold temperature. Furthermore, using crosslinked polymers enabled the resulting foams to have an increased strength, an increased specific gravity, and a decreased average cell size, compared to using non-crosslinked polymers. Such microcellular foam can be used as the material for, protective athletic pads, and the like.

### Example 3-4

### The Manufacture of Ethylene Vinyl Acetate Copolymer (EVA) Microcellular Foams

In Examples 3 and 4, microcellular foams were made using EVA manufactured by USI Far East corporation, Taiwan. The EVA used in Example 3 additionally contained only additives. The EVA used in Example 4 contained a chemical foaming agent in addition to the same additives as used in Example 3. Initially, the EVA was made into a plate. The plate was placed in a mold and heated. The mold was charged with supercritical carbon dioxide, and then opened to cause pressure reduction, forming a microcellular foam article. The supercritical fluids, mold temperatures, and mold pressures used for making various samples, and the properties for the samples are shown in Table 1.

As known from the data shown in Table 1, chemical foaming agents had an effect mainly on the specific gravity. The microcellular foam had a relatively low expansion ratio but a relatively high stability when a chemical foaming agent was used. Such microcellular foam can be used as the material for shoes, protective athletic pads, and the like.

TABLE 1
Results of examples 1-4

| | | | | | | | Break | Yield |
|---|---|---|---|---|---|---|---|---|
| Sample | | Sp. | Mold Temp. | Mold Press | Ave. cell | elongation | Strength | Strength |
| No. | gas | Gr. | (° C.) | (psi) | size (μm) | % | Kg_{f}/cm² | Kg_{f}/cm² |
| 1-1 | CO₂ | 0.715 | 45 | 4200 | 21 | 450 | 43.11 | 45.25 |
| 1-1 | CO₂ | 0.653 | 70 | 4300 | 26 | 450 | 48.12 | 49.03 |
| 1-1 | CO₂ | 0.158 | 80 | 4400 | 39 | 450 | 55.77 | 56.33 |
| 2-1 | CO₂ | 0.937 | 45 | 4200 | 12 | 300 | 19.91 | 27.44 |
| 2-1 | CO₂ | 0.682 | 70 | 4300 | 22 | 350 | 20.01 | 24.41 |
| 2-1 | CO₂ | 0.472 | 80 | 4400 | 28 | 400 | 21.92 | 22.06 |
| 3 | CO₂ | 0.186 | 80 | 4400 | 39 | 300 | 27.98 | 29.41 |
| 4 | CO₂ | 0.227 | 80 | 4400 | 38 | 350 | 26.68 | 27.34 |

### Example 5

### The Manufacture of High Impact Polystyrene (HIPS) Microcellular Foams

In Example 5, microcellular foams were made using HIPS (Trademark: “PH88S”, density=1.05 g/cm³, flow index=3.0 g/10 min, glass transition temperature (i.e. Tg )=about 90° C.) manufactured by Chi Mei Corporation, Tainan County, Taiwan. Initially, PH88S was made into a plate. The plate was placed in a mold and heated. The mold was charged with supercritical carbon dioxide, and then opened to cause pressure reduction, forming a microcellular foam article. The supercritical fluids, mold temperatures, and mold pressures used for making various samples, and the specific gravity of the samples are shown in Table 2.

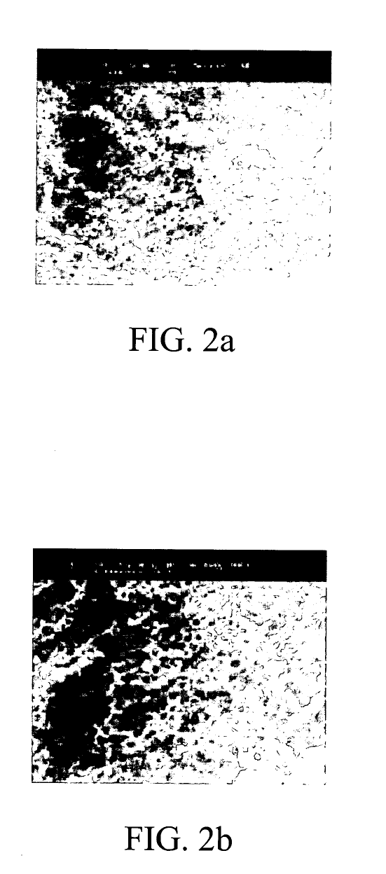

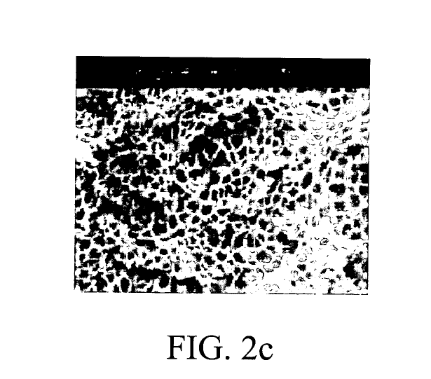

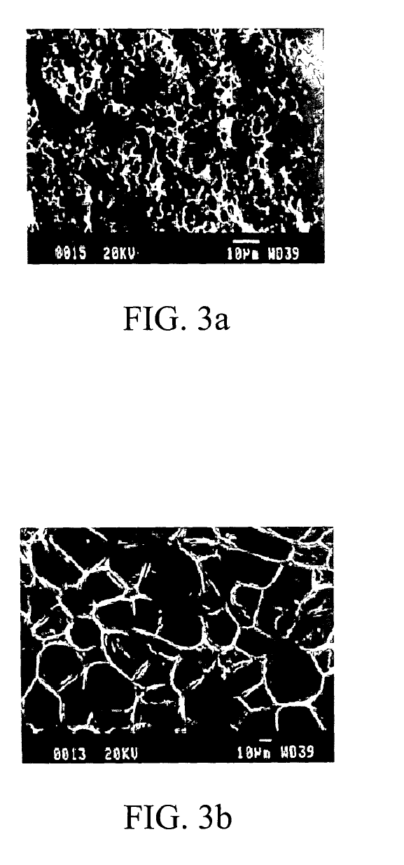

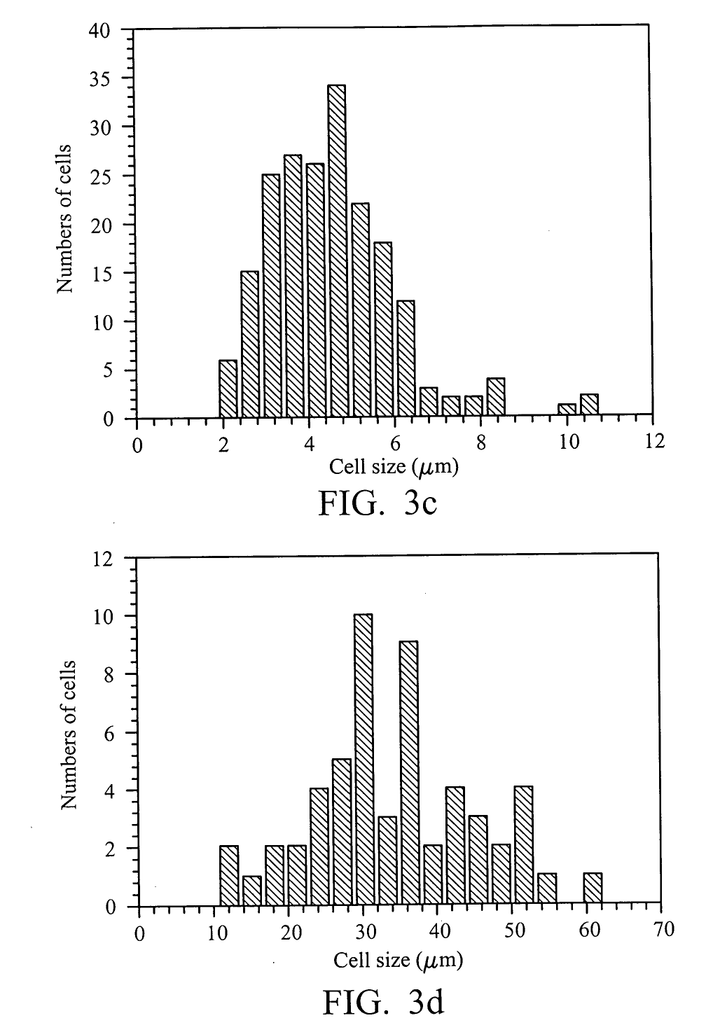

As known from the data shown in Table 2, the factor which most influenced the specific gravity of the foam was the mold temperature, referring to FIGS. 2a, 2b, and 2c. For the variation of cell sizes of HIPS foam, the average cell sizes of sample No. 5-4, 5-6, and 5-9 were 3 μm, 8 μm, and 10 μm, respectively, as shown in FIGS. 2a, 2b, and 2c, respectively. When the mold temperature was lower than Tg, the foam with lower expansion ratio had a higher specific gravity. When the mold temperature was higher than Tg, the foam with higher expansion ratio had a lower specific gravity and a larger cell size, referring to FIGS. 3a to 3b, but a relatively high cell density and, accordingly, a greatly reduced mechanical strength. For the distribution of cell sizes of HIPS foam, the average cell size of sample No. 5-1 was 4.3 μm, as shown in FIGS. 3a and 3c, and the average cell size of sample No. 5-12 was 32.8 μm, as shown in FIGS. 3b and 3d. Such phenomenon showed that a foaming process in a nearly solid state was feasible using a foaming temperature below Tg. The resulting foam had an expansion ratio less than 2 and could be used for structural material. On the other hand, the HIPS foam obtained by a liquid state foaming process using a temperature higher than Tg had an expansion ratio more than 10 and could be used for packing material.

TABLE 2
Results of Example 5

| Samples | | Mold Temp., | Mold Press., | |
|---|---|---|---|---|
| No. | Gas | ° C. | psi | Sp. Gr. |
| 5-1 | CO₂ | 85 | 2000 | 0.645 |
| 5-2 | CO₂ | 85 | 3000 | 0.609 |
| 5-3 | CO₂ | 85 | 4000 | 0.498 |
| 5-4 | CO₂ | 90 | 3000 | 0.414 |
| 5-5 | CO₂ | 95 | 3000 | 0.372 |
| 5-6 | CO₂ | 100 | 3000 | 0.323 |
| 5-7 | CO₂ | 105 | 3000 | 0.263 |
| 5-8 | CO₂ | 110 | 2000 | 0.237 |
| 5-9 | CO₂ | 110 | 3000 | 0.213 |
| 5-10 | CO₂ | 110 | 4000 | 0.198 |
| 5-11 | CO₂ | 110 | 5000 | 0.180 |
| 5-12 | CO₂ | 135 | 2000 | 0.055 |
| 5-13 | CO₂ | 135 | 3000 | 0.064 |
| 5-14 | CO₂ | 135 | 4000 | 0.051 |

### Example 6

### The Manufacture of Metallocene Cycloolefin Copolymer Microcellular Foams

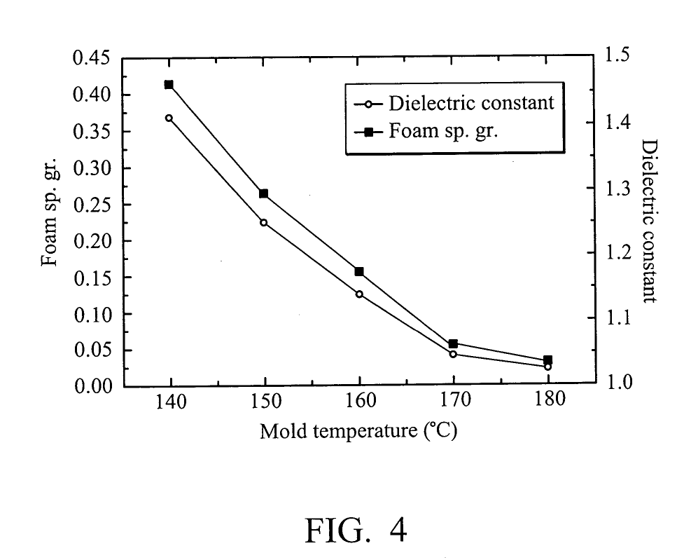

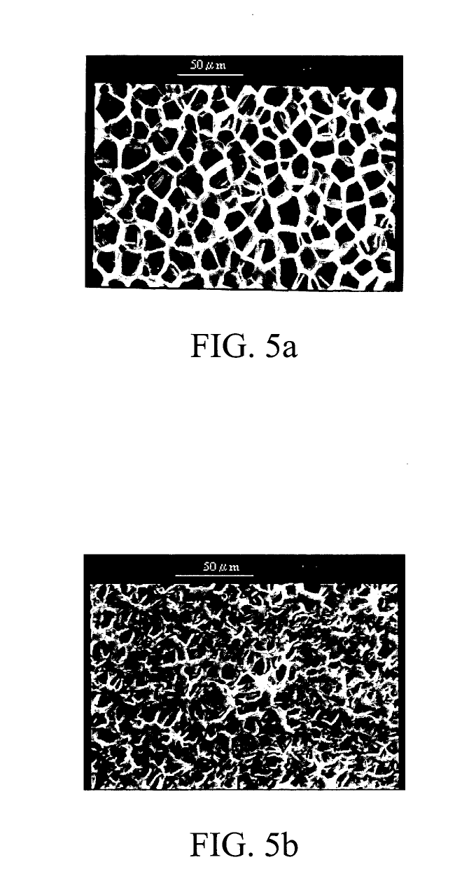

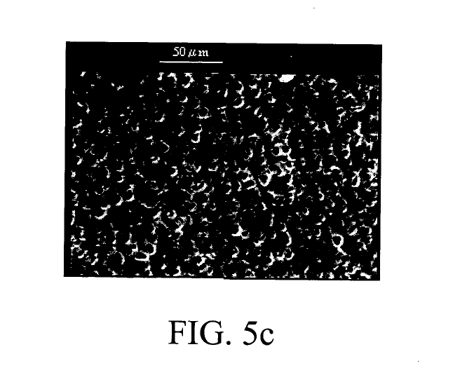

In Example 6, microcellular foams were made using metallocene cycloolefin copolymer (Trademark: Topas 5013, density=1.02 g/cm³, flow index=57.0 g/10 min, Tg=about 130° C.) manufactured by Ticona Corporation, Germany. mCOC is a transparent plastic material having a high Tg and can be used in optoelectric related products. Topas 5013 has a high flowability and is mainly used in injection molding of optical plastic parts. Initially, Topas was made into a plate. The plate was placed in a mold and heated. The mold was charged with supercritical carbon dioxide at 4000 psi, and then opened to cause pressure reduction, forming a microcellular foam article. FIG. 4 shows the specific gravity of foam increases as the mold temperature decreases. The distribution of the specific gravities of microcellular foam obtained at a temperature from 140 to 180° C. ranged from 0.416 to 0.0332, and the cell sizes decreased from 20 μm to below 10 μm. As the correlation between dielectric constant and mold temperature shown from FIG. 4, the dielectric constant decreased as the specific gravity decreased. Furthermore, it was found that the dielectric constant gradually increased in 30 days to reach a constant value. Such variation increased as the specific gravity decreased, and the rate of variation was within 5%, showing that even mCOC foamed, it still had excellent water resistance to limit the moisture permeation and thus the dielectric constant increased little. The result shows the mCOC microcellular foam having high heat resistance and a low dielectric constant can be used as electric insulating material, for example, high frequency substrate or outer sheath material for coaxial cable.

### EXAMPLES 7-8

### The Manufacture of Chemically Crosslinked Ethylene Vinyl Acetate Microcellular Foams

In Example 7, Microcellular foams were made using commercial foaming raw material for twice-compressed midsole, which contained EVA, a chemical foaming agent, a chemical crosslinking agent, and other additives. Example 8 differed from Example 7 only in that the foaming raw material did not contain a chemical foaming agent. The raw material was formed as a sheet and placed in a mold and heated. The mold was charged with supercritical nitrogen, and then opened to cause pressure reduction, forming a microcellular foam article. The supercritical fluids, mold temperatures and mold pressures used for making various foam samples, and the specific gravities for the resulting samples are shown in Table 3.

As known from the data shown in Table 3, the microcellular foam made at the crosslinking temperature of about 155˜175° C. using the method of the present invention had a specific gravity less than 0.1 and an average cell size less than 30 μm, compared to conventional foamed material made by a simple compression and chemical foaming method, which has a specific gravity of about 0.13˜0.15 and an average cell size of about 100 μm. Furthermore, the foamed article of this example was relatively light and fine and had mechanical properties similar to the conventional one and excellent surface texture, in addition to the relatively decreased specific gravity. The present examples used supercritical liquids as foaming agents, and the resulting microcellular foam had good stability. Such microcellular foam can be used as material for shoes, protective athletic pads, or the material demanding high-quality surface texture.

TABLE 3
Results of Examples 7-8

| | | Mold | | |
|---|---|---|---|---|
| Samples | | Temp., | Mold | |
| No. | Gas | ° C. | Press., psi | Sp. Gr. |
| 7-1 | N₂ | 150 | 4000 | 0.043 |
| 7-2 | N₂ | 155 | 4000 | 0.038 |
| 7-3 | N₂ | 160 | 4000 | 0.040 |
| 7-4 | N₂ | 165 | 4000 | 0.038 |
| 7-5 | N₂ | 170 | 4000 | 0.039 |
| 7-6 | N₂ | 180 | 4000 | 0.036 |
| 8-1 | N₂ | 150 | 4000 | 0.072 |
| 8-2 | N₂ | 155 | 4000 | 0.061 |
| 8-3 | N₂ | 160 | 4000 | 0.061 |
| 8-4 | N₂ | 165 | 4000 | 0.054 |
| 8-5 | N₂ | 170 | 4000 | 0.055 |
| 8-6 | N₂ | 180 | 4000 | 0.052 |

### EXAMPLES 9-11

### The Manufacture of Chemically Crosslinked Polyethylene Microcellular Foams

In Examples 9-11, different microcellular foams were made using three different shoe material preparations, each containing different PE combinations, chemical crosslinking agents, and additives, wherein a chemical foaming agent was used in Example 11. The shoe material preparation was formed as a sheet and placed in a mold and heated. The mold was charged with supercritical nitrogen or carbon dioxide, or in the combination with nitrogen, and then opened to cause pressure reduction, forming a microcellular foam article. The original sheet thickness, supercritical fluids, mold temperatures and mold pressures used for making various foam samples, and the specific gravities for the resulting samples are shown in Table 4.

As known from the data shown in Table 4, the method of the present invention could produce microcellular foam from an original sheet with a thickness of 30 mm. The foamed article had an expansion ratio of more than 15 and a thickness of above 8 cm, with a uniform distribution of cell sizes less than 30 μm on the cross section along the thickness direction of the foamed article, with excellent surface texture. Such microcellular foam can be used as material for shoes, protective athletic pads, thermal insulation, or the material demanding high-quality texture surface.

TABLE 4
Results of Examples 9-11

| | | | Mold | Mold | |
|---|---|---|---|---|---|
| Samples | Thickness, | | Temp., | Press., | |
| No. | mm | Gas | ° C. | psi | Sp. Gr. |
| 9-1 | 2.5 | N₂ | 150 | 3000 | 0.048 |
| 9-2 | 30.0 | N₂ | 150 | 3000 | 0.064 |
| 10-1 | 2.5 | N₂ | 150 | 3000 | 0.052 |
| 10-2 | 30.0 | N₂ | 150 | 3000 | 0.078 |
| 10-3 | 2.5 | CO₂ | 110 | 1500 | 0.040 |
| 11 | 10.0 | CO₂ | 170 | 4000 | 0.043 |

### Examples 12-14

### The Manufacture of Irradiation-Crosslinked Polyethylene Microcellular Foams

In Examples 12-14, different microcellular foams were made using three different shoe material preparations, each containing different PE combinations and additives, wherein 11 Mrad of electron beam was used for crosslinking in Examples 12-13 and 11 Mrad of γ-ray was used for crosslinking in Example 14. The shoe material preparation was formed as a sheet and placed into a plate. The plate was placed in a mold and heated. The mold was charged with supercritical carbon dioxide, or in combination with nitrogen, and then opened to cause pressure reduction, forming a microcellular foam article. The original sheet thickness, mold temperatures and mold pressures used for making various foam samples, and the specific gravities for the resulting samples are shown in Table 5.

As known from the data shown in Table 5, the foaming temperature for the electron beam-crosslinked polyethylene sheet was not as high as in the prior art to make microcellular foam having an expansion ratio more than 10 and an average cell size less than 30 μm. The mechanical and physical properties were appropriate and the surface texture was good in addition to the decrease of specific gravity. Such microcellular foam can be used as the material for shoe material, protective athletic pads, or material demanding high-quality surface texture.

TABLE 5
Results of Examples 12-14

| | | | Mold | Mold | |
|---|---|---|---|---|---|
| Samples | Thickness, | | Temp., | Press., | |
| No. | mm | Gas | ° C. | psi | Sp. Gr. |
| 12-1 | 4.0 | CO₂ | 97 | 2000 | 0.103 |
| 12-2 | 4.0 | CO₂ | 97 | 3000 | 0.049 |
| 12-3 | 4.0 | CO₂ | 97 | 4000 | 0.046 |
| 13 | 3.1 | CO₂ | 90 | 5000 | 0.067 |
| 14 | 8.0 | CO₂ + N₂ | 100 | 3000 | 0.075 |

### Examples 15-17

### The Manufacture of Metallocene Cycloolefin Copolymer/Linear Low Density Polyethylene (LDPE) Blends Microcellular Foams

In Examples 15-17, different microcellular foams were made using different metallocene cycloolefin copolymer (Trademark: Topas 6013, 6015, and 6017, manufactured by Ticona Corporation) and LDPE blends. Initially, 15 wt % of metallocene cycloolefin copolymer and additives were blended with LPDE and placed into a plate. The plate was placed in a mold and heated. The mold was charged with supercritical carbon dioxide, and then opened to cause pressure reduction, forming a microcellular foam article. The mold temperatures and mold pressures used for making various samples, and the properties for the samples are shown in Table 1.

As known from Table 6, after the addition of Topas having high Tg, foaming did not take place at a temperature as low as 80° C. The specific gravity of foam decreased as the mold temperature increased. In example 17, the Tg of Topas was relatively high, so that the specific gravity of foam was apparently relatively large. All these foam samples were microcellular foam, and the average cell sizes were less than 30 μm. Microcellular foam formed using the blends referred here can be used as the material for thermal insulation, leakage prevention, shock absorbers, and the like.

TABLE 6
Results of Examples 15-17

| | Mold | Mold | Sp. Gr. Of Samples | | |
|---|---|---|---|---|---|
| Samples | Temp., | Press., | Example | Example | Example |
| No. | ° C. | psi | 15 | 16 | 17 |
| −1 | 100 | 4000 | 0.102 | 0.135 | 0.197 |
| −2 | 100 | 3000 | 0.063 | 0.106 | 0.161 |
| −3 | 100 | 5000 | 0.123 | 0.221 | 0.231 |
| −4 | 90 | 5000 | 0.191 | 0.342 | 0.339 |
| −5 | 80 | 5000 | >1 | >1 | >1 |

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of manufacturing polymeric foam using supercritical fluids, comprising the steps of:
(a) placing a foamable polymeric material in a mold;
(b) introducing a supercritical fluid through the mold at a first temperature and at a first pressure for a time period sufficient to impregnate the polymeric material; and
(c) changing the first temperature and the first pressure to a second temperature and a second pressure sufficient to produce the polymeric foam having microcells.

2. The method as claimed in claim 1, wherein the method is performed using a compression molding machine.

3. The method as claimed in claim 1, wherein the method is performed using an injection molding machine.

4. The method as claimed in claim 1, wherein the supercritical fluid is a supercritical gas.

5. The method as claimed in claim 4, wherein the supercritical fluid is supercritical carbon dioxide or supercritical nitrogen.

6. The method as claimed in claim 1, wherein the polymeric material is selected from a group consisting of thermoplastics, thermoplastic elastomers, partially crosslinked thermoplastics, partially crosslinked thermoplastic elastomers, crosslinked thermoplastics, crosslinked thermoplastic elastomers, and the combination thereof.

7. The method as claimed in claim 6, wherein the polymeric material contains a chemical foaming agent.

8. The method as claimed in claim 6, wherein the polymeric material contains a chemical crosslinking agent.

9. The method as claimed in claim 6, wherein a chemical crosslinking is performed in the mold.

10. The method as claimed in claim 6, wherein a physical crosslinking is performed in the mold.

11. The method as claimed in claim 1, wherein the polymeric material in step (a) is a shaped foamable article.

12. The method as claimed in claim 11, wherein the polymeric material is a particulate-shaped foamable article.

13. The method as claimed in claim 11, wherein the polymeric material is a foamable article in a form of sheet.

14. The method as claimed in claim 11, wherein the polymeric material is a foamable article in a molten state.

15. The method as claimed in claim 1, wherein, in step (a), the mold is fully filled with the polymeric material.

16. The method as claimed in claim 1, wherein, in step (a), the mold is partly filled with the polymeric material.

17. The method as claimed in claim 1, wherein the temperature of the mold is adjustable.

18. The method as claimed in claim 1, wherein the polymeric foam obtained by the method is microcellular foam.

19. The method as claimed in claim 1, wherein the polymeric foam obtained by the method is microcellular crosslinked foam.
